(19) United States
(12) Patent Application Publication
(10) Pub. No.: US 2025/0023828 A1
(43) Pub. Date: Jan. 16, 2025

(54) Queue-Size Limitations in Virtual Queue Systems

(71) Applicant: TELEFONAKTIEBOLAGET LM ERICSSON (PUBL), Stockholm (SE)

(72) Inventors: Victor Millnert, Bjärred (SE); Emma Wittenmark, Lund (SE); Christer Östberg, Staffanstorp (SE)

(21) Appl. No.: 18/711,549

(22) PCT Filed: Nov. 18, 2021
(86) PCT No.: PCT/EP2021/082121

§ 371 Date: May 17, 2024

(51) Int. Cl. H04L 47/50; H04L 47/11; H04L 47/12

(52) U.S. Cl. CPC H04L 47/50; H04L 47/11; H04L 47/12

(57) ABSTRACT

There is provided mechanisms for controlling queue-size of a virtual queue system for an incoming traffic flow of packets. The incoming traffic flow of packets is by a scheduler scheduled for user equipment as an outgoing traffic flow. The virtual queue system is configured to represent a real queue system of the scheduler by estimating a virtual delay for the packets. The virtual delay is estimated by measuring the incoming traffic flow and estimating the outgoing traffic flow. The method is performed by a network node. A method comprises adaptively controlling a maximum queue-size and a minimum queue-size of the virtual queue system as a function of measured traffic rate of the incoming traffic flow, current congestion level of the virtual queue system, estimated traffic rate of the outgoing traffic flow, and queue-size of the real queue system.

### TECHNICAL FIELD

Embodiments presented herein relate to a method, a network node, a computer program, and a computer program product for controlling queue-size of a virtual queue system for an incoming traffic flow of packets.

### BACKGROUND

Current wireless communication networks are enabled to host high-throughput services, such as streaming services. One reason for this is the use of buffers in strategic places along the applications traffic paths in the wireless communication network. However, this might not be sufficient for wireless communication networks to be able to host low-latency services since the current wireless communication networks might cause jitter and latency-spikes for applications hosted on top of the radio access network part of the wireless communication network.

Such latency spikes and jitter might appear when congestion occurs in the radio access network. Therefore, if it was possible to reduce the congestion by reducing the throughput of the applications sufficiently fast, the latency spikes and jitter might be reduced.

Techniques to address this issue will be disclosed next. Some of the techniques involve the use of congestion marking within the wireless communication network. Some of the techniques involve over-the-top solutions, where congestion is addressed at transmission control protocol (TCP) level. The main focus of the present disclosure is the former, i.e., when the congestion marking is performed from within the wireless communication network, where the actual congestion occurs.

For low-latency, low-loss, scalable throughput (L4S) services, one alternative is to set up a new, dedicated bearer, for the L4S-traffic, and then dynamically (or statically) control the amount of time/frequency resources allocated to the different bearers. This allows the wireless communication network to differentiate between non-L4S traffic (such as mobile broadband (MBB) traffic) and L4S traffic, allowing the non-L4S traffic to have the typical high-throughput but with jittery traffic characteristics, and the L4S traffic to have low-latency characteristics.

One approach to realize this is to run a virtual system in parallel with the real system. In other words, a virtual queue in the radio access network is set up and it is estimated how long it will take the virtual system to process this virtual queue. By doing so, it is possible to also estimate a virtual delay for processing of the incoming packets. Should this virtual delay be larger than a certain threshold, some of the incoming packets are marked as congested. Packets marked as congested will act as indicators to the application server that the application server should lower the rate by which it sends the packets, thus eventually alleviating the congestion.

One issue with the foregoing approach is that there is no bound on how large or small the virtual queue can be.

In some scenarios this may lead to that the virtual queue grows too large. This in turn might lead to an integral wind-up behavior. This means that the virtual queue grows so large, and thereby also the virtual delay, that all packets will be marked as congested. In such a case the virtual queue may already have grown so large that packets are continually marked as congested despite the fact that the congestion in the real system may already have been resolved. In other words, the virtual queue may grow so large that packets are marked as congested for an unnecessarily long time, leading to subpar performance (e.g., a lowered throughput).

In other scenarios this may lead to that the virtual queue does not grow large enough, i.e., it might be too small. This might occur if the virtual system is poorly modeled and does not properly capture the processing in the real system. Some examples of situations like this might be unmodeled change in the link capacity or hybrid automatic repeat request (HARQ) retransmissions of another bearer (leading to the L4S bearer being temporarily under-prioritized in the scheduler). When this occurs, the real system experiences a congestion. However, since it is not modeled in the virtual system, it will not lead to an increase of the virtual queue, and thus no packets are marked as congested.

### SUMMARY

An object of embodiments herein is to address the above issues. In general terms, the above issues are addressed by providing a virtual queue system where the queue-size is neither too large, nor too small.

According to a first aspect there is presented a method for controlling queue-size of a virtual queue system for an incoming traffic flow of packets. The incoming traffic flow of packets is by a scheduler scheduled for user equipment as an outgoing traffic flow. The virtual queue system is configured to represent a real queue system of the scheduler by estimating a virtual delay for the packets. The virtual delay is estimated by measuring the incoming traffic flow and estimating the outgoing traffic flow. The method is performed by a network node. The method comprises adaptively controlling a maximum queue-size and a minimum queue-size of the virtual queue system as a function of measured traffic rate of the incoming traffic flow, current congestion level of the virtual queue system, estimated traffic rate of the outgoing traffic flow, and queue-size of the real queue system.

According to a second aspect there is presented a network node for controlling queue-size of a virtual queue system for an incoming traffic flow of packets. The incoming traffic flow of packets is by a scheduler scheduled for user equipment as an outgoing traffic flow. The virtual queue system is configured to represent a real queue system of the scheduler by estimating a virtual delay for the packets. The virtual delay is estimated by measuring the incoming traffic flow and estimating the outgoing traffic flow. The network node comprises processing circuitry. The processing circuitry is configured to cause the network node to adaptively control a maximum queue-size and a minimum queue-size of the virtual queue system as a function of measured traffic rate of the incoming traffic flow, current congestion level of the virtual queue system, estimated traffic rate of the outgoing traffic flow, and queue-size of the real queue system.

According to a third aspect there is presented a network node for controlling queue-size of a virtual queue system for an incoming traffic flow of packets. The incoming traffic flow of packets is by a scheduler scheduled for user equipment as an outgoing traffic flow. The virtual queue system is configured to represent a real queue system of the scheduler by estimating a virtual delay for the packets. The virtual delay is estimated by measuring the incoming traffic flow and estimating the outgoing traffic flow. The network node comprises a control module configured to adaptively control a maximum queue-size and a minimum queue-size of the virtual queue system as a function of measured traffic rate of the incoming traffic flow, current congestion level of the virtual queue system, estimated traffic rate of the outgoing traffic flow, and queue-size of the real queue system.

According to a fourth aspect there is presented a computer program for controlling queue-size of a virtual queue system for an incoming traffic flow of packets, the computer program comprising computer program code which, when run on a network node, causes the network node to perform a method according to the first aspect.

According to a fifth aspect there is presented a computer program product comprising a computer program according to the fourth aspect and a computer readable storage medium on which the computer program is stored. The computer readable storage medium could be a non-transitory computer readable storage medium.

Advantageously, these aspects enable the virtual queue-size to be matched to the behaviour of the real queue system.

Advantageously, by adaptively controlling the maximum queue-size, these aspects enable the integral wind-up problem of the virtual queue system to be resolved.

Advantageously, these aspects enable the number of packets that are unnecessarily marked as congested to be reduced.

Advantageously, these aspects enable the applications sending the traffic flow to achieve a higher throughput.

Advantageously, by adaptively controlling the minimum queue-size, these aspects resolve issues with uncaptured congestions due to poor modeling of the physical system.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, action, etc.” are to be interpreted openly as referring to at least one instance of the element, apparatus, component, means, module, action, etc., unless explicitly stated otherwise. The actions of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a wireless communication network according to embodiments:

FIG. 2 is a block diagram of a wireless communication network according to embodiments:

FIG. 3 is a block diagram of a network node according to embodiments:

FIG. 4 is a flowchart of methods according to embodiments:

FIG. 5 is a schematic diagram showing functional units of a network node according to an embodiment:

FIG. 6 is a schematic diagram showing functional modules of a network node according to an embodiment; and

FIG. 7 shows one example of a computer program product comprising computer readable storage medium according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein: rather, these embodiments are provided by way of example so that this disclosure will be thorough and complete, and will fully convey the scope of the inventive concept to those skilled in the art. Like numbers refer to like elements throughout the description. Any action or feature illustrated by dashed lines should be regarded as optional.

FIG. 1 is a schematic diagram illustrating an example wireless communication network 100 where embodiments presented herein can be applied. The wireless communication network 100 could be a third generation (3G) telecommunications network, a fourth generation (4G) telecommunications network, a fifth generation (5G) telecommunications network, or any evolvement thereof, and support any 3GPP telecommunications standard, where applicable. The wireless communication network 100 could alternatively be a non-cellular and/or a non-3GPP network, such as an IEEE 802.11 communications network, or any other wireless IEEE compliant communications network. The communication wireless network 100 comprises a network node 200 provided in a (radio) access network 110. The network node 200 is configured to, via a transmission and reception point 140, provide network access to user equipment 150a, 150b. The (radio) access network 110 is operatively connected to a core network 120. The core network 120 is in turn operatively connected to a service network 130, such as the Internet. An application server 170 is provided in the service network 130 to represent services available in the service network 130. The user equipment 150a, 150b are thereby enabled to, via the network node 200 and its transmission and reception point 140, access services of, and exchange data with, the service network 130. Examples of network nodes 200 are radio access network nodes, radio base stations, base transceiver stations. Node Bs, evolved Node Bs, gNBsm access points, and integrated access and backhaul nodes. Examples of user equipment 150a, 150b are wireless devices, mobile stations, mobile phones, handsets, wireless local loop phones, smartphones, laptop computers, tablet computers, network equipped sensors, network equipped vehicles, and so-called Internet of Things devices.

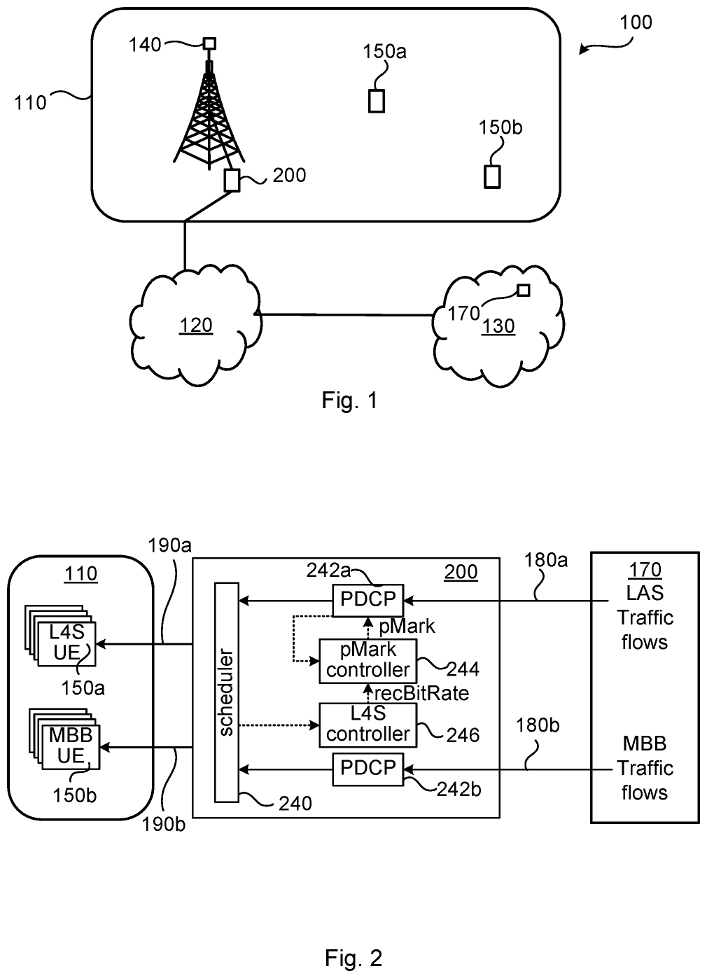

As noted above, an object of embodiments herein is to address issues, in particular relating to the queue-size of the virtual queue in the virtual queue system. In general terms, the above issues are addressed by providing a virtual queue system where the queue-size is adaptively controlled to be neither too large, nor too small. To further illustrate this, a high-level block diagram of a wireless communication network comprising a network node configured to reduce congestion and thereby achieve low-latency is illustrated in FIG. 2. In FIG. 2 is illustrated two bearers being established between an application server 170 and user equipment 150a, 150b. The two bearers are for two traffic flow-types: the bearer for user equipment 150a is for an LAS traffic flow and the bearer for user equipment 150b is for a non-L4S traffic flow, such as an MBB traffic flow. Without loss of generality, to achieve a consistent and low latency for the L4S traffic flow, the L4S traffic flow has a higher priority in the scheduler 240 than the non-L4S traffic flow. However, also other scheduler mechanism can be used to ensure this.

In more detail, network node obtains two incoming traffic flows 180a, 180b from the application server 170, where traffic flow 180a represents an L4S traffic flow and traffic flow 180b represents non-L4S traffic flow. Before reaching the scheduler 240, which provides two corresponding outgoing traffic flows 190a, 190b towards the user equipment 150a, 150 in the access network 110, the incoming traffic flows 180a, 180b are processed by a respective Packet Data Convergence Protocol (PDCP) block 242a. 242b. A pMark controller 244 is configured to determine whether incoming packets in the incoming traffic flow 180a are to be marked as congested or not. The decision is based on information received from a L4S controller 246 which in turn monitors the behavior of the scheduler 240. If a packet is marked as congested, this will lead to a reduction of the throughput of this traffic flow from the application server 170. This is done once the packet has been acknowledged by the application server 170 which sent it (e.g., once the packet has been received by the user equipment 150a, and whose acknowledgement has been sent back to the application server 170). The reason for the reduction in throughput is because the congestion marking signals a congestion event, which will cause the application server 170 to lower its throughput.

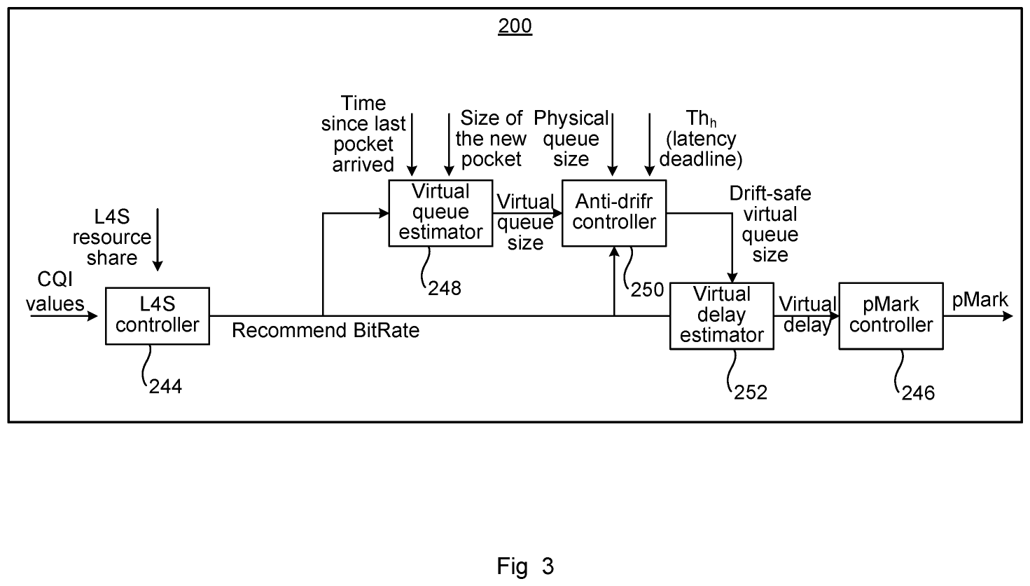

A block diagram of a network node 200 illustrating how the pMark controller 244 is configured to determine whether incoming packets in the incoming traffic flow 180a are to be marked as congested or not is shown in FIG. 3. An LAS-controller 244 is configured to monitor incoming channel quality information (CQI) values along with what the dedicated resource-share for the L4S traffic is. Based on this, the L4S-controller 244 computes a recommended bitrate, which corresponds to the estimated traffic rate which the L4S traffic flow should get in the scheduler 240. There is also provided a virtual-queue estimator 248, a virtual-delay estimator 252, an anti-drift controller 250, and the pMark controller 246. The virtual queue estimator 248 is configured to keep a virtual version of the real queue system (e.g., at radio link control (RLC) level) for the L4S traffic flow. The virtual queue-size is updated every time a new packet arrives, according to the following pseudo-code:

tNow = getTime( ); # get current time
vQueue = vQueue − recommendedBitRate * (tNow − tLastUpdate); #
estimate how much queue-size has
reduced
vQueue = max(0, vQueue); # ensure that queue-size is not negative
vQueue = vQueue + sizeOfNewPacket; # calculate new queue-size
tLastUpdate = tNow; # store time value for latest update

Hence, each time a new packet is entered into the queue it is estimated how much of the queue has disappeared since the last packet was entered (i.e., how much the queue-size has reduced), it is ensured that the queue-size is not negative, and the queue-size is incremented according to the newly received packet.

Based on the updated virtual queue-size, the virtual delay-estimator 252 estimates the queue-delay for the incoming packets, according to the following pseudo-code:

vDelay=vQueue/recommendedBitRate: # virtual delay is ratio of queue-size and recommended bitrate

Finally, the pMark controller 246 determines whether the incoming packet should be marked as congested or not. It does so based on the virtual delay and two thresholds: a Lower congestion threshold (Th_L), and an upper congestion threshold (Th_H). In some aspects, the thresholds are regarded the upper and lower latency bounds for the L4S traffic flows. As an example, all packets will be marked as congested if the virtual latency is above Th_H, and no packets will be marked as congested if the virtual latency is below Th_L. The values of these parameters might be specified when setting up the system. In some examples, packets are marked as congested according to the following criterion:

$$pMark ( t ) = {[ \frac{vDelay ( t ) - {Th}_{L}}{{Th}_{H} - {Th}_{L}} ]}_{0}^{1}$$

In other words, pMark(t) is a ramp between 0 and 1, where the ramp grows linearly as the virtual delay, vDelay(t), grows from Th_L to Th_H. Therefore, no packets are marked as congested when vDelay Th_L, and all packets are marked as congested when vDelay>Th_H. When Th_L<vDelay<Th_H, the proportion of packets marked as congested follows the value of pMark (1). That is, if pMark(t)=x, where 0<x<1, then there is a probability of x that a packet will be marked as congested.

It is in the above equation that the drift-problems are manifested. In more detail, whenever the value of vQueue grows too large, this will also lead to that the value of vDelay growing too large (i.e., larger than Th_H). Hence, the value of vQueue then needs to be reduced by a potentially very large amount before vDelay(t)<Th_H. It will not be until this occurs that the pMark controller 244 will begin to reduce the amount of packets it marks as congested.

To address this issue, it is proposed to use an adaptive maximum queue-size of the virtual queue as well as an adaptive minimum queue-size of the virtual queue. This adaptive control of the maximum queue-size and the minimum queue-size (and hence at least some of the herein disclosed embodiments that relate to this) can be implemented by the anti-drift controller 250 in FIG. 3.

The embodiments disclosed herein in particular relate to mechanisms for controlling queue-size of a virtual queue system for an incoming traffic flow 180a of packets. In order to obtain such mechanisms there is provided a network node 200, a method performed by the network node 200, a computer program product comprising code, for example in the form of a computer program, that when run on a network node 200, causes the network node 200 to perform the method.

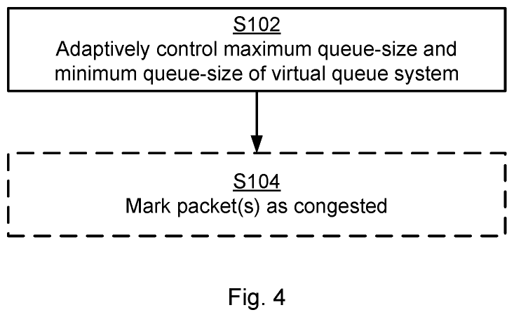

FIG. 4 is a flowchart illustrating embodiments of methods for controlling queue-size of a virtual queue system for an incoming traffic flow 180a of packets. The virtual queue system is implemented as, or at least acts as, a digital twin of the real queue system. The methods are performed by the network node 200. The methods are advantageously provided as computer programs 720.

In particular, the incoming traffic flow 180a of packets is by a scheduler 240 scheduled for user equipment 150a as an outgoing traffic flow 190a. Further, the virtual queue system is configured to represent a real queue system of the scheduler 240 by estimating a virtual delay for the packets. The virtual delay is estimated by the network node 200 measuring the incoming traffic flow 180a and estimating the outgoing traffic flow 190a. The virtual queue system has a virtual queue that is upper-limited in queue-size by a maximum queue-size and lower-limited by a minimum queue-size.

S102: The network node 200 adaptively controls the maximum queue-size and the minimum queue-size of the virtual queue system. The maximum queue-size and the minimum queue-size is adaptively controlled as a function of measured traffic rate of the incoming traffic flow 180a, current congestion level of the virtual queue system, estimated traffic rate of the outgoing traffic flow 190a, and queue-size of the real queue system.

This method resolves the above-mentioned issues by introducing an adaptive anti-drift mechanism (as represented by the adaptively controlled maximum queue-size and minimum queue-size of the virtual queue system) to the virtual system. This method ensures that the virtual queue-size does not drift too far from the real queue-size. This method therefore protects the virtual system from missing congestion situation as well as from marking an unnecessary amount of packets as congested.

Embodiments relating to further details of for controlling queue-size of a virtual queue system for an incoming traffic flow 180a of packets as performed by the network node 200 will now be disclosed.

There might be different types of traffic flows. As in the example of FIG. 2, in some embodiments the incoming traffic flow 180a is an LAS traffic flow.

Aspects of how the maximum queue-size can be adaptively controlled will be disclosed next.

In some aspects, the maximum queue-size is adaptively controlled such that the virtual delay is limited to Th_H as defined above. That is, in some embodiments, the congestion is represented by a lower congestion threshold value (such as Th_L) and an upper congestion threshold value (such as Th_H), and the maximum queue-size is adaptively controlled to limit the virtual delay to not exceed the upper congestion threshold value.

The queue-size does not need to be any larger since when vDelay=Th_H, it follows that pMark=1 (and all packets are marked as congested). Therefore, in some aspects, the maximum queue-size is limited according to the following equation:

$$vQueueMax ( t ) = {Th}_{H} * recommendedBitRate ( t )$$

leading to the wind-up safe virtual queue-size being computed as vQueue=min (vQueue, vQueueMax). Hence, in some embodiments, the maximum queue-size is a product of the upper congestion threshold value and the estimated traffic rate of the outgoing traffic flow 190a.

As disclosed above, all incoming packets are marked as congested when the virtual latency is equal to, or greater, than Th_H, e.g., when vDelay≥Th_H. Also recalling that the latency (e.g., vDelay) is computed by dividing the virtual queue size (e.g., vQueueSize) with the recommended bitrate (e.g., the estimated processing rate), the following relationship is obtained:

$$pMark = 1 < - > vQueueSize / recommendedBitRate \geq Th\_H$$

From this relationship it can be derived that the limit of vQueueSize where all incoming packets are marked as congested is given by:

$$vQueueSize \geq Th\_H * recommendedBitRate = > pMark = 1$$

This is one motivation why vQueueMax=Th_H*recommendedBitRate.

Additional embodiments, aspects, alternatives, and examples of how the maximum queue-size can be adaptively controlled will be disclosed next.

In some aspects, the aforementioned product of the upper congestion threshold value and the estimated traffic rate of the outgoing traffic flow 190a is subjected to filtering, or other types of processing. Particularly, in some embodiments, the product of the upper congestion threshold value and the estimated traffic rate of the outgoing traffic flow 190a is low-pass filtered. This might remove short-time effect that would otherwise cause the maximum queue-size to be abruptly changed over time. In some aspects, the aforementioned product of the upper congestion threshold value and the estimated traffic rate of the outgoing traffic flow 190a is multiplied with a system constant. Particularly, in some embodiments, the product of the upper congestion threshold value and the estimated traffic rate of the outgoing traffic flow 190a is scaled with a scaling factor >1. The low-pass filtering might be combined with scaling. In some aspects, the maximum queue-size is a function of previous values of the maximum queue-size. In order to achieve this, a sliding window is applied and only previous values of the maximum queue-size that are larger than some threshold value are considered. In particular, in some embodiments, the maximum queue-size is a function of previous values of the maximum queue-size that are larger than a lower limit maximum queue-size threshold value, and wherein the function only considers previous values of the maximum queue-size within a time window. For example, the time window (that defines the sliding window) can have a length of Y1 minutes and the X1 largest values within this time window are taken into consideration when determining the maximum queue-size (for example as a mean value of the X1 largest values within the time window).

In some aspects, the recommended bitrate (corresponding to the estimated traffic rate of the outgoing traffic flow 190a) is estimated based on parameter values (and thus artificially recreated). According to some non-limiting examples, the estimated traffic rate of the outgoing traffic flow 190a is a function of at least one of: power headroom reports, channel quality information (CQI) reports, radio conditions of the user equipment 150a to which the L4S traffic flow is to be scheduled, the number of user equipment 150a to which the L4S traffic flow is to be scheduled, the total share of resources available to be scheduled for the user equipment 150a to which the L4S traffic flow is to be scheduled.

In some aspects, the maximum queue-size is adaptively controlled to be equal to the current queue-size of the virtual queue system. This could be the case when a packet is marked as congested. That is, if pMark is true, then the value of vQueueSize (where vQueueSize is the current queue-size of the virtual queue system) can be recorded and stored as maxValue (where maxValue is the maximum queue-size). Hence, in some embodiments, whenever any of the packets is marked as congested, the maximum queue-size is equal to a current queue-size of the virtual queue system. This can be expressed according to the following pseudo-code:

IF (pMark = 1) {
maxValue = vQueueSize;
}

This embodiment might also be combined with the use of a sliding window, low-pass filter, scaling factor, or similar approaches.

Aspects of how the minimum queue-size can be adaptively controlled will be disclosed next. In some embodiments, the minimum queue-size (denoted vQueueMin) is equal to, or larger than, the queue-size (denoted realQueueSize) of the real queue system or to a configured parameter. Ensuring that the virtual queue is at least as large as the real queue avoids the virtual queue-size to be too small. In this way, situations where there is a congestion in the real queue system which is not directly captured by the virtual queue system can be avoided, thus providing a safeguard against poor modeling of the virtual queue system and unforeseen events in the real queue system.

In some aspects the minimum queue-size is to be adaptively controlled with an aim to avoid situations where the real queue-size is larger than the virtual queue-size, one reason for this is because in such a scenario, the virtual queue system has drifted away from the real system, and enough packets have not been marked as congested. This can be achieved by ensuring that vQueueSize≥realQueueSize. An alternative to this is to consider the queue delay of the real queue system instead of the queue-size of the real queue system. Hence, in some embodiments, the minimum queue-size is equal to a product of the queue-delay of the real queue system and the estimated traffic rate of the outgoing traffic flow 190a. This corresponds to determining the minimum queue-size vQueueMin as:

vQueueMin=realDelay*recommendedBitRate;

As for the maximum queue-size, also the expression for the minimum queue-size can be filtered. Particularly, in some embodiments, the product of the queue delay of the real queue system and the estimated traffic rate of the outgoing traffic flow 190a is low-pass filtered. This might remove short-time effect that would otherwise cause the minimum queue-size to be abruptly changed over time. In some aspects, the aforementioned product of the of the queue delay of the real queue system and the estimated traffic rate of the outgoing traffic flow 190a is multiplied with a system constant, or subjected to other types of processing. Particularly, in some embodiments, the product of the queue-delay of the real queue system and the estimated traffic rate of the outgoing traffic flow 190a is scaled with a scaling factor ≠1. This allows for both up-scaling and down-scaling of the minimum queue-size of the virtual queue system.

The low-pass filtering might be combined with scaling. In some aspects, the minimum queue-size is a function of previous values of the minimum queue-size. In order to achieve this, a sliding window is applied and only previous values of the minimum queue-size that are larger than some threshold value are considered. In particular, in some embodiments, the minimum queue-size is a function of previous values of the minimum queue-size that are larger than a lower limit minimum queue-size threshold value, where the function only considers previous values of the minimum queue-size within a time window. For example, the time window (that defines the sliding window) can have a length of Y2 minutes and the X2 largest values within this time window are taken into consideration when determining the minimum queue-size (for example as a mean value of the X2 largest values within the time window).

In some aspects, the delay of the real queue system is compared to a minimum delay limit and the minimum queue-size of the virtual queue system is adaptively controlled when the delay of the real queue system exceeds the minimum delay limit. This can be expressed according to the following pseudo-code:

IF (realDelay > minDelayLimit) {
vQueueMin = realDelay * recommendedBitRate;
}

The recommended bitrate (corresponding to the estimated traffic rate of the outgoing traffic flow 190a) can be estimated based on parameter values (and thus artificially recreated) as disclosed above.

Aspects of marking packets as congested will be disclosed next.

In some examples, a packet is marked as congested when the virtual queue-delay is larger than threshold Th_L. Hence, in some examples the network node 200 is configured to perform (optional) action S104:

S104: The network node 200 marks at least some of the packets of the incoming traffic flow 180a of packets as congested when the virtual delay for the packets is larger than a lower congestion threshold value.

In some examples, the congestion marking function pMark is dependent on vDelay. That is, in some examples, whether to mark said at least some of the packets as congested or not is a function of the virtual delay.

In some examples, the virtual delay is a ratio between the current queue-size of the virtual queue system and the estimated traffic rate of the outgoing traffic flow 190a. That is, expressed in pseudo-code:

vDelay=vQueue/recommendedBitRate;

In some examples, the value of vQueue is impacted by the value of vQueueMax and the value of vQueueMin. That is, in some examples, the current queue-size of the virtual queue system is dependent on the maximum queue-size and the minimum queue-size of the virtual queue system.

In some examples, the congestion markings will signal to the application server 170 that the application server 170 should lower its rate by which it sends packets towards the network node 200. That is, the packets marked as congested provides an indication for lowering the bitrate of the incoming traffic flow 180a.

At least some of the above disclosed embodiments, aspects, and examples for adaptively controlling the maximum queue-size and the minimum queue-size of the virtual queue system can be expressed as follows in pseudo-code:

tNow = getTime( ); # get current time
vQueue = vQueue − recommendedBitRate * (tNow − tLastUpdate); #
estimate how much queue-size has
reduced
vQueue = max(0, vQueue); # ensure that queue-size is not negative
vQueue = vQueue + sizeOfNewPacket; # calculate new queue-size
vQueueMax = Th_H * recommendedBitRate; # limit the virtual
queue-size from above
vQueue = min(vQueue, vQueueMax); # limit the virtual queue-size
from above
realQueueSize = getRealQueueSize( ); # get the real queue-size of
the physical system
vQueueMin = realQueueSize or Config parameter # limit the virtual
queue-size from below
vQueue = max(vQueueMin, vQueue); # limit the virtual queue-size
from below
tLastUpdate = tNow; # store time value for latest update

Thus, if the queue-size of the real queue system for some reason grows to be larger than the maximum queue-size of the virtual queue system (e.g., realQueueSize>vQueueMax), the herein disclosed embodiments will ensure that the queue-size of the virtual queue system indeed follows the queue-size of the real queue system.

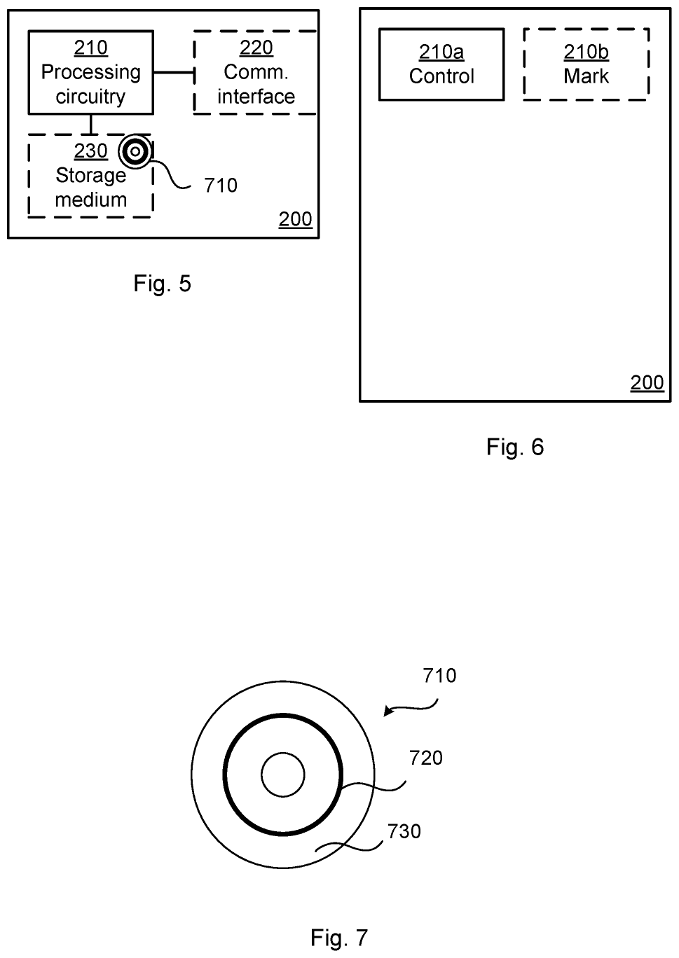

FIG. 5 schematically illustrates, in terms of a number of functional units, the components of a network node 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 710 (as in FIG. 7). e.g. in the form of a storage medium 230. The processing circuitry 210 may further be provided as at least one application specific integrated circuit (ASIC), or field programmable gate array (FPGA).

Particularly, the processing circuitry 210 is configured to cause the network node 200 to perform a set of operations, or actions, as disclosed above. For example, the storage medium 230 may store the set of operations, and the processing circuitry 210 may be configured to retrieve the set of operations from the storage medium 230 to cause the network node 200 to perform the set of operations. The set of operations may be provided as a set of executable instructions.

Thus the processing circuitry 210 is thereby arranged to execute methods as herein disclosed. The storage medium 230 may also comprise persistent storage, which, for example, can be any single one or combination of magnetic memory, optical memory, solid state memory or even remotely mounted memory. The network node 200 may further comprise a communications interface 220 at least configured for communications with other entities, functions, nodes, and devices. As such the communications interface 220 may comprise one or more transmitters and receivers, comprising analogue and digital components. The processing circuitry 210 controls the general operation of the network node 200 e.g. by sending data and control signals to the communications interface 220 and the storage medium 230, by receiving data and reports from the communications interface 220, and by retrieving data and instructions from the storage medium 230. Other components, as well as the related functionality, of the network node 200 are omitted in order not to obscure the concepts presented herein.

FIG. 6 schematically illustrates, in terms of a number of functional modules, the components of a network node 200 according to an embodiment. The network node 200 of FIG. 6 comprises a control module 210a configured to perform action S102. The network node 200 of FIG. 6 may further comprise a number of optional functional modules, such as a mark module 210b configured to perform action S104. In general terms, each functional module 210a: 210b may in one embodiment be implemented only in hardware and in another embodiment with the help of software. i.e., the latter embodiment having computer program instructions stored on the storage medium 230 which when run on the processing circuitry makes the network node 200 perform the corresponding actions mentioned above in conjunction with FIG. 6. It should also be mentioned that even though the modules correspond to parts of a computer program, they do not need to be separate modules therein, but the way in which they are implemented in software is dependent on the programming language used. Preferably, one or more or all functional modules 210a: 210b may be implemented by the processing circuitry 210, possibly in cooperation with the communications interface 220 and/or the storage medium 230. The processing circuitry 210 may thus be configured to from the storage medium 230 fetch instructions as provided by a functional module 210a: 210b and to execute these instructions, thereby performing any actions as disclosed herein.

The network node 200 may be provided as a standalone device or as a part of at least one further device. For example, the network node 200 may be provided in a node of the radio access network or in a node of the core network. Alternatively, functionality of the network node 200 may be distributed between at least two devices, or nodes. These at least two nodes, or devices, may either be part of the same network part (such as the radio access network or the core network) or may be spread between at least two such network parts. In general terms, instructions that are required to be performed in real time may be performed in a device, or node, operatively closer to the cell than instructions that are not required to be performed in real time.

Thus, a first portion of the instructions performed by the network node 200 may be executed in a first device, and a second portion of the of the instructions performed by the network node 200 may be executed in a second device: the herein disclosed embodiments are not limited to any particular number of devices on which the instructions performed by the network node 200 may be executed. Hence, the methods according to the herein disclosed embodiments are suitable to be performed by a network node 200 residing in a cloud computational environment. Therefore, although a single processing circuitry 210 is illustrated in FIG. 5 the processing circuitry 210 may be distributed among a plurality of devices, or nodes. The same applies to the functional modules 210a: 210b of FIG. 6 and the computer program 720 of FIG. 7.

FIG. 7 shows one example of a computer program product 710 comprising computer readable storage medium 730. On this computer readable storage medium 730, a computer program 720 can be stored, which computer program 720 can cause the processing circuitry 210 and thereto operatively coupled entities and devices, such as the communications interface 220 and the storage medium 230, to execute methods according to embodiments described herein. The computer program 720 and/or computer program product 710 may thus provide means for performing any actions as herein disclosed.

In the example of FIG. 7, the computer program product 710 is illustrated as an optical disc, such as a CD (compact disc) or a DVD (digital versatile disc) or a Blu-Ray disc. The computer program product 710 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 720 is here schematically shown as a track on the depicted optical disk, the computer program 720 can be stored in any way which is suitable for the computer program product 710.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1.-18. (canceled)

19. A method for controlling queue-size of a virtual queue system for an incoming traffic flow of packets,
wherein the incoming traffic flow of packets is by a scheduler scheduled for user equipment as an outgoing traffic flow,
wherein the virtual queue system is configured to represent a real queue system of the scheduler by estimating a virtual delay for the packets, the virtual delay being estimated by measuring the incoming traffic flow and estimating the outgoing traffic flow,
wherein the method is performed by a network node, and wherein the method comprises:
adaptively controlling a maximum queue-size and a minimum queue-size of the virtual queue system as a function of a measured traffic rate of the incoming traffic flow, a current congestion level of the virtual queue system, an estimated traffic rate of the outgoing traffic flow, and a queue-size of the real queue system.

20. The method according to claim 19, wherein the incoming traffic flow is a low-latency, low-loss, scalable throughput (L4S) traffic flow.

21. The method according to claim 19, wherein the congestion is represented by a lower congestion threshold value and an upper congestion threshold value, and wherein the maximum queue-size is adaptively controlled to limit the virtual delay to not exceed the upper congestion threshold value.

22. The method according to claim 21, wherein the maximum queue-size is a product of the upper congestion threshold value and the estimated traffic rate of the outgoing traffic flow.

23. The method according to claim 22, wherein the product of the upper congestion threshold value and the estimated traffic rate of the outgoing traffic flow is low-pass filtered.

24. The method according to claim 22, wherein the product of the upper congestion threshold value and the estimated traffic rate of the outgoing traffic flow is scaled with a scaling factor >1.

25. The method according to claim 19, wherein the maximum queue-size is a function of previous values of the maximum queue-size that are larger than a lower limit maximum queue-size threshold value, and wherein the function only considers previous values of the maximum queue-size within a time window.

26. The method according to claim 20, wherein the estimated traffic rate of the outgoing traffic flow is a function of at least one of: power headroom reports, channel quality information reports, radio conditions of the user equipment to which the L4S traffic flow is to be scheduled, number user equipment to which the L4S traffic flow is to be scheduled, or total share of resources available to be scheduled for the user equipment to which the L4S traffic flow is to be scheduled.

27. The method according to claim 19, wherein, whenever any of the packets is marked as congested, the maximum queue-size is equal to a current queue-size of the virtual queue system.

28. The method according to claim 19, wherein the real queue system has a queue-size, and wherein the minimum queue-size is equal to the queue-size of the real queue system or to a configured parameter.

29. The method according to claim 19, wherein the real queue system has a queue-delay, and wherein the minimum queue-size is equal to a product of the queue-delay of the real queue system and the estimated traffic rate of the outgoing traffic flow.

30. The method according to claim 29, wherein the product of the queue-delay of the real queue system and the estimated traffic rate of the outgoing traffic flow is scaled with a scaling factor #1.

31. The method according to claim 19, wherein the minimum queue-size is a function of previous values of the minimum queue-size that are larger than a lower limit minimum queue-size threshold value, and wherein the function only considers previous values of the minimum queue-size within a time window.

32. A network node for controlling queue-size of a virtual queue system for an incoming traffic flow of packets,
wherein the incoming traffic flow of packets is by a scheduler scheduled for user equipment as an outgoing traffic flow, and
wherein the virtual queue system is configured to represent a real queue system of the scheduler by estimating a virtual delay for the packets, the virtual delay being estimated by measuring the incoming traffic flow and estimating the outgoing traffic flow,
wherein the network node comprises processing circuitry configured to cause the network node to:
adaptively control a maximum queue-size and a minimum queue-size of the virtual queue system as a function of a measured traffic rate of the incoming traffic flow, a current congestion level of the virtual queue system, an estimated traffic rate of the outgoing traffic flow, and a queue-size of the real queue system.

33. The network node of claim 32, wherein the incoming traffic flow is a low-latency, low-loss, scalable throughput (L4S) traffic flow.

34. The network node of claim 32, wherein the congestion is represented by a lower congestion threshold value and an upper congestion threshold value, and wherein the maximum queue-size is adaptively controlled to limit the virtual delay to not exceed the upper congestion threshold value.

35. The network node of claim 34, wherein the maximum queue-size is a product of the upper congestion threshold value and the estimated traffic rate of the outgoing traffic flow.

36. The network node of claim 35, wherein the product of the upper congestion threshold value and the estimated traffic rate of the outgoing traffic flow is:
low-pass filtered; and/or
scaled with a scaling factor >1.

37. The network node of claim 32, wherein the maximum queue-size is a function of previous values of the maximum queue-size that are larger than a lower limit maximum queue-size threshold value, and wherein the function only considers previous values of the maximum queue-size within a time window.

38. A non-transitory computer-readable storage medium on which is stored a computer program for controlling queue-size of a virtual queue system for an incoming traffic flow of packets,
wherein the incoming traffic flow of packets is by a scheduler scheduled for user equipment as an outgoing traffic flow, and
wherein the virtual queue system is configured to represent a real queue system of the scheduler by estimating a virtual delay for the packets, the virtual delay being estimated by measuring the incoming traffic flow and estimating the outgoing traffic flow,
the computer program comprising computer code which, when run on processing circuitry of a network node, causes the network node to:
adaptively control a maximum queue-size and a minimum queue-size of the virtual queue system as a function of measured traffic rate of the incoming traffic flow, current congestion level of the virtual queue system, estimated traffic rate of the outgoing traffic flow, and queue-size of the real queue system.
